(19) United States
(12) Patent Application Publication
(10) Pub. No.: US 2007/0050054 A1
(43) Pub. Date: Mar. 1, 2007

(54) Mobile communication terminal with virtual remote control

(75) Inventors: Guru Corattur Sambandam Guruparan, Cary, NC (US); Allen Michael East, Cary, NC (US)

Correspondence Address: COATS & BENNETT/SONY ERICSSON, 1400 CRESCENT GREEN, SUITE 300, CARY, NC, 27511, US

(73) Assignee: Sony Ericssson Mobile Communications AB

(21) Appl. No.: 11/212,457

(22) Filed: Aug. 26, 2005

(51) Int. Cl. G05B 19/18; G05B 15/00

(52) U.S. Cl. 700/65; 700/83; 700/66

(57) ABSTRACT

A mobile terminal is configured to download a virtual remote control for a device to be controlled, wherein the virtual remote control includes a graphical interface corresponding to that device. The terminal is further configured to display the virtual remote control, and to transmit commands to the device responsive to receiving user inputs directed to the displayed virtual remote control. The terminal's display screen may be a touch screen display, and the user inputs may be touches directed to graphical facsimiles of control buttons. Regardless, the virtual remote control generally comprises a graphic that mimics or otherwise provides a facsimile of all or a portion of the control layout of a dedicated remote control corresponding to the device to be controlled.

### BACKGROUND

The present invention relates to mobile terminals, such as cellular radiotelephones and the like, and particularly relates to incorporating intuitive remote control functionality into such terminals.

Multiple remote controls lying around are a hallmark of modern life. Greater interest in more sophisticated home entertainment systems accounts in large measure for the increased number of individual remote controls in the home. For example, a typical home theater system commonly includes at least a television, a stereo, a DVD player, and some type of set-top box. In the traditional paradigm of remote controls, four components from four different manufacturers equals four different remote controls.

The ability of each device manufacturer to tailor its corresponding remote control to the features and capabilities of its device represents one advantage of this approach to providing consumers with remote controls. That is, a remote control specially intended for controlling a given device, or a given class of devices, generally offers its user a more straightforward and intuitive control layout, as compared to “universal” remote controls.

Universal remote controls attempt to integrate remote control functions from a variety of device types or classes of devices, so that the consumer needs only one remote control to control all of his or her audio/video (A/V) equipment. While the consolidation of multiple remote controls into one universal remote control is good in theory, and does offer certain practical advantages, it is not without its detractions.

For example, one approach to providing increased functionality takes the straightforward, if inelegant, approach of simply adding as many buttons as there are different functions to support. Many people are familiar with this class of universal remote control, festooned with its many small, and sometimes indecipherable, buttons. More sophisticated universal remote controls provide multifunction buttons that take on different control tasks depending on the mode or setting of the universal remote control.

While the reuse of buttons for multiple functions does reduce the overall button count, it sometimes forces a compromise in terms of the intuitiveness of the layout, and the sheer range of devices intended to be controlled by most universal remote controls still requires a significant number of buttons in the control layout.

The potentially cleaner approach involves the use of display screens to provide varying sets of soft buttons on an LCD screen or the like. Generally, these approaches suffer in that the soft button layouts are not intuitive or matched to the control layout intended for a particular device to be controlled. Moreover, the use of LCD screens in universal remotes drives up their cost significantly.

### SUMMARY

A method of supporting remote control of other devices by a mobile terminal comprises downloading a virtual remote control to the mobile terminal for a device to be controlled by the mobile terminal, displaying the virtual remote control on a display screen of the mobile terminal, and transmitting commands to the device responsive to receiving user inputs directed to the virtual remote control. The virtual remote control includes a graphical interface corresponding to the device to be controlled, such that a user of the mobile terminal is presented with a graphic representing at least a portion of a control layout of a dedicated remote control associated with the device to be controlled.

In at least one embodiment, the graphic comprising the virtual remote control is a graphical “skin” representing all or part of the dedicated remote control. Thus, the user of the mobile terminal is presented with a facsimile of the remote control associated with the device, and a number of different skins may be downloaded and stored in the mobile terminal, for a variety of devices, such as for multiple pieces of ANV equipment in a home theater system.

In the context of the above method, downloading the virtual remote control may comprise receiving the virtual remote control from the device to be controlled, through a local communication link between the mobile terminal and the device. That link may be infrared, or may be another type of short-range interface, including Bluetooth, WiFi, or the like. In other embodiments, the mobile terminal may download the virtual remote control from a wireless communication network that stores, or otherwise has access to, virtual remote control information. In such embodiments, the mobile terminal uses its cellular communication interface to obtain virtual remote controls from a database or server accessible through the cellular network.

In other embodiments, the mobile terminal provides a local communication interface that is configured to communicate with a computer, and receives the virtual remote control through a computer based downloading process. This approach allows the user to access a web page or the like from which virtual remote controls may be downloaded and transferred to the mobile terminal.

Regardless of such variations, according to the methods taught herein, a mobile terminal displays a virtual remote control as a graphic representing the control layout of at least a portion of a remote control intended for a particular device to be controlled, or classes of devices to be controlled, using the mobile terminal's display screen. The user thus is presented with a facsimile of the device's control layout, thereby providing the user with a familiar set of controls for the device. Advantageously, the mobile terminal's display screen is configured as a touch screen display, such that the user simply presses locations on the touch screen corresponding to the various displayed controls.

Of course, the present invention is not limited to the above features and advantages. Indeed, those skilled in the art will recognize additional features and advantages upon reading the following detailed discussion, and upon viewing the accompanying drawings.

### BRIEF DESCRIPTION OF THE DRAWINGS

FIG. 1 is an illustration of a mobile terminal configured to display a virtual remote control on an included display screen.

FIG. 2 is a diagram of a conventional dedicated remote control, such as might commonly be associated with AN equipment.

FIG. 3 is an illustration of the mobile terminal shown in FIG. 1, but with an alternative virtual remote control embodiment depicted.

FIG. 4 is an illustration of a mobile terminal display screen, displaying a menu of selectable virtual remote controls, corresponding to different pieces of A/V equipment to be controlled.

FIG. 5 is a block diagram of mobile terminal details.

FIG. 6 is a block diagram of additional mobile terminal details.

FIG. 7 is a logic flow diagram, illustrating processing logic associated with downloading a virtual remote control to a mobile terminal.

FIG. 8 is a logic flow diagram, illustrating processing logic supporting the downloading of a virtual remote control according to another embodiment.

FIG. 9 is a logic flow diagram, illustrating processing logic associated with downloading a virtual remote control according to another embodiment.

### DETAILED DESCRIPTION

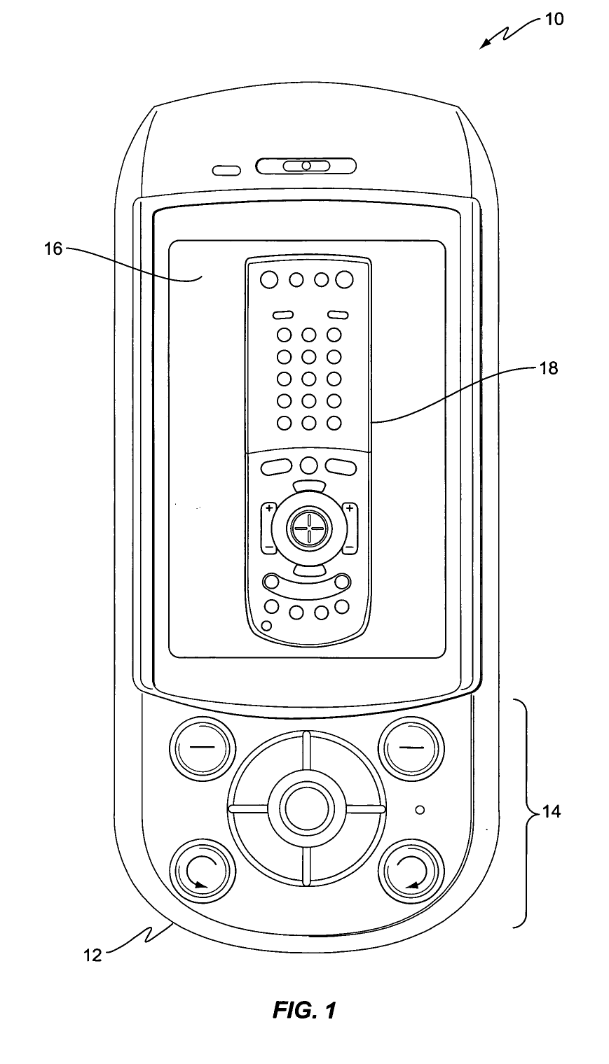

FIG. 1 illustrates an embodiment of a mobile terminal 10, whose enclosure 12 includes control inputs 14, and a display screen 16. The mobile terminal 10, which may comprise a cellular radiotelephone or the like, is configured to display a virtual remote control 18 on the display screen 16, and is configured to transmit remote control commands to a device—e.g., stereo, TV, etc.—to be controlled responsive to receiving user inputs directed to the virtual remote control 18.

The virtual remote control 18 includes a graphical interface corresponding to the device to be controlled by the mobile terminal 10. More particularly, the mobile terminal 10 displays the virtual remote control 18 on the display screen 16 as a graphic representing at least a portion of the control layout of a dedicated remote control associated with the device to be controlled. In this context, the term “dedicated” remote control generally connotes the remote control from the device's manufacturer, or otherwise connotes a remote control intended to control a given type of device.

The graphic may be a graphical “skin” representing all or part of the dedicated remote control. Indeed, the display screen 16 may comprise a graphical color display, allowing a realistic depiction of all or part of the dedicated remote control. As such, the mobile terminal 10 presents its user with a virtual remote control 18 offering a control layout that presumably is already familiar to the user.

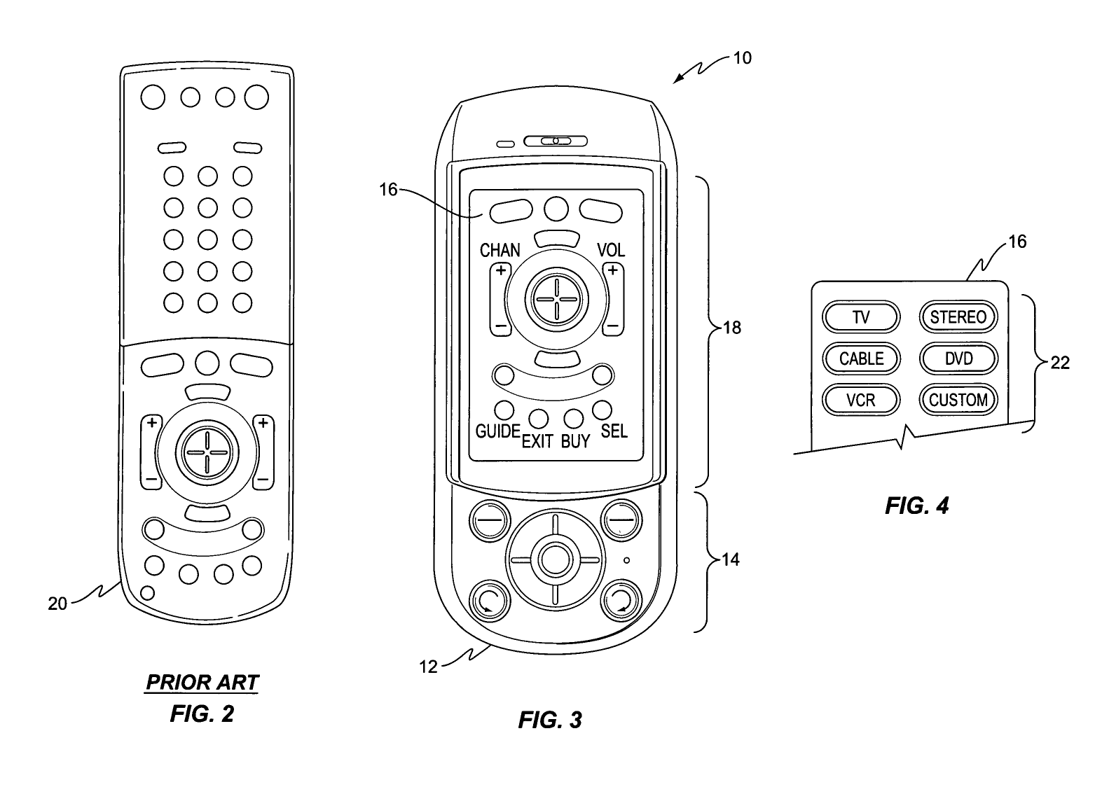

For example, FIG. 2 illustrates a conventional remote control 20 commonly associated with satellite or cable set-top boxes. Referring back to FIG. 1, one sees that the mobile terminal 10 may display the virtual remote control 18 as a graphical facsimile of the dedicated remote control 20. However, even if the display screen 16 is capable of displaying the virtual remote control 18 as a representation of the entire remote control 20, it still may be advantageous to display only a selected portion, or selected portions, of the remote control 20.

FIG. 3 illustrates such an approach, wherein the virtual remote control 18 comprises a subset of the “buttons” included in the overall control layout of the remote control 20. With this approach, the virtual remote control 18 may comprise an enlarged or more detailed representation of selected control elements corresponding to particular functions of the remote control 20.

Further, FIG. 4 illustrates that the mobile terminal 10 may be configured to use the display screen 16 for displaying a graphical menu of devices to be controlled. For example, the mobile terminal 10 may display a collection of device buttons 22 such that the mobile terminal 10 displays a virtual remote control 18 for a particular device in response to the user selecting one of the device menu buttons 22. To that end, it should be understood that the mobile terminal 10 may store a plurality of virtual remote controls 18, and may provide on-screen menus, e.g., hierarchical device/function selections, on the display screen 16 to allow users to move between virtual remote controls 18, and to select a particular virtual remote control 18 for a particular device to be controlled.

Advantageously, the display screen 16 may be implemented as a touch screen display. In such embodiments, a user of the mobile terminal 10 “operates” a displayed virtual remote control 18 simply by directing touch inputs to screen locations corresponding to control elements (e.g., “buttons”) of the virtual remote control 18. Additionally, or alternatively, at least some of the virtual remote control's functions can be mapped to controls 14 of the mobile terminal 10. For example, as an added convenience, a readily accessible control input of the mobile terminal 10 may be mapped to a master volume or muting function.

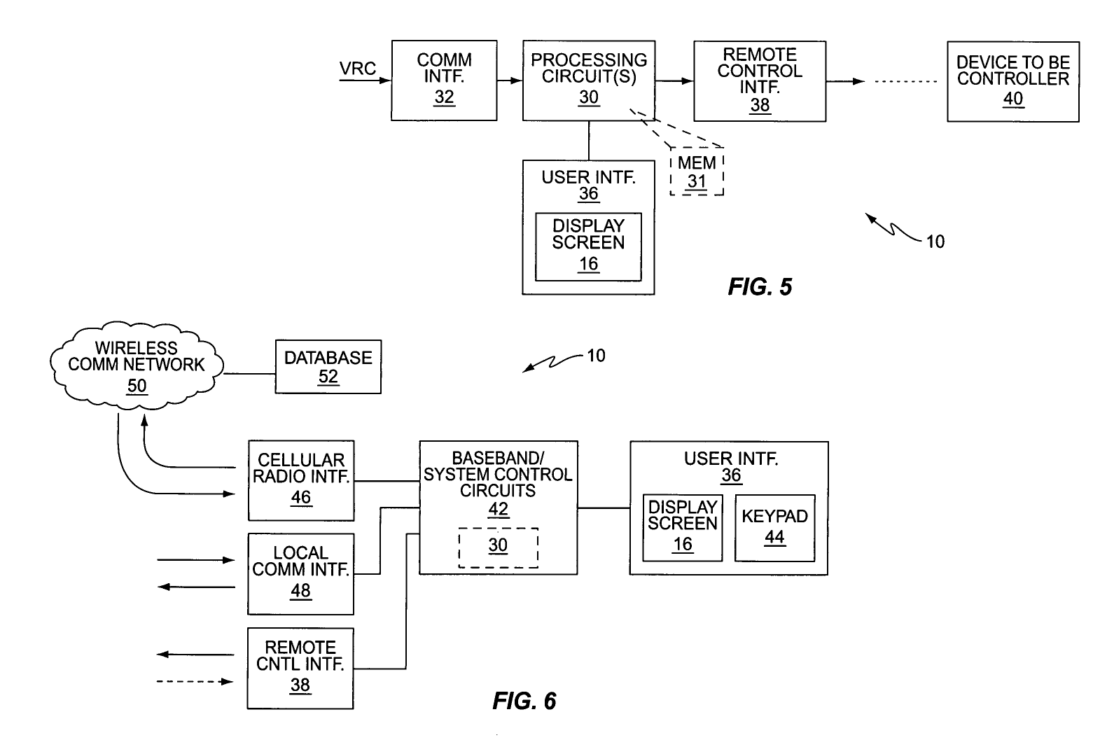

Regardless of such details, FIG. 5 illustrates one embodiment of the mobile terminal 10, comprising one or more processing circuits 30, a communication interface 32, a user interface 36, which generally includes the display screen 16, and a remote control interface 38. The remote control interface 38 may comprise an infrared emitter (and detector, if configured as a bi-directional control interface). Alternatively, or additionally, the remote control interface 38 may comprise a radiofrequency control interface. In either case, the remote control interface 38 should be configured for broad compatibility.

In operation, the one or more processing circuits 30 are configured to download a virtual remote control 18 via the communication interface 32, display the virtual remote control 18 on the display screen 16, and transmit remote control commands to a device 40 via the remote control interface 38, responsive to user inputs directed to the virtual remote control 18 displayed on the display screen 16.

Note that the device to be controlled 40 represents any one of a number of devices, and typically represents a selected piece of AN equipment. As noted before, the mobile terminal 10 may store and selectively display a number of virtual remote controls 18, corresponding to different pieces of AN equipment, and may include a menu system allowing the user to move between and select particular virtual remote controls 18.

FIG. 6 represents a more detailed illustration of the mobile terminal 10 according to one embodiment. Additional details illustrated include baseband/system control circuits 42, a keypad 44, a cellular communication interface 46, and a local communication interface 48. The baseband/system control circuits 42, which may comprise one or more microprocessors or digital signal processors, may include the one or more processing circuits 30 illustrated in FIG. 5. Further, the keypad 44 may be included in, or associated with, the user interface 36.

The local communication interface 48 may comprise a Bluetooth interface, or other short-range wireless interface, such as WiFi or infrared (e.g., iRDA), or may comprise a computer data interface, such as USB or IEEE 1394 (Firewire). In all such cases, the local communication interface 48 may be configured to communicate with the device 40 and/or to communicate with a computer (PC).

As such, the mobile terminal 10 may be configured to download the virtual remote control 18 directly from the device 40, through the local communication interface 48, assuming that the device 40 includes a compatible communication interface and stores the necessary information. Alternatively, or additionally, the mobile terminal 10 may be configured to download the virtual remote control 18 from a supporting wireless communication network 50, which includes or is associated with a server/database 52 that includes virtual remote control information. As a further addition or alternative, the mobile terminal 10 may be configured to download the virtual remote control 18 from a computer (PC) through the local communication interface 48.

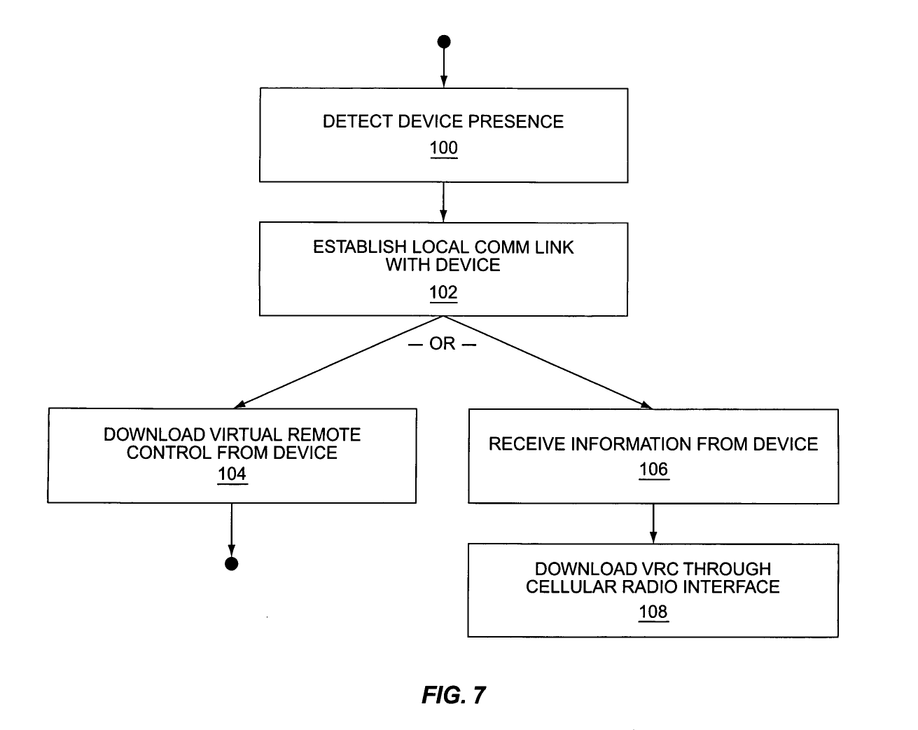

With these embodiments in mind, FIG. 7 illustrates one embodiment of virtual remote control downloading, wherein it is assumed that the device 40 includes a communication interface that is compatible with the mobile terminal 10. The downloading operation begins with the mobile terminal 10 detecting the device's presence (Step 100).

Such detection may occur automatically, such as where the local communication interface 48 of the mobile terminal 10 is a Bluetooth interface that can automatically detect and establish a communication link with a compatible Bluetooth interface of the device 40. Downloading operations continue with establishment of a local communication link between the mobile terminal 10 and the device 40 (Step 102).

One advantage to this approach is that the mobile terminal 10 can acquire virtual remote controls 18, as needed, as the mobile terminal's user moves into proximity with one or more devices to be controlled—e.g., as the user walks into a home theater or entertainment room. With automatic detection and downloading, the process of obtaining needed virtual remote controls 18 can be essentially transparent to the user of the mobile terminal 10, and can be particular convenient for setting up and integrating new devices 40 into the user's entertainment system.

For example, the mobile terminal 10 could retain identifiers for equipment for which it already has virtual remote controls 18 stored, automatically detect the presence of a new device 40, and acquire the virtual remote control 18 for that new device 40, without requiring any specific user intervention. Of course, the mobile terminal 10 could be configured to prompt the user, or to otherwise request permission to carry out the process.

In any case, if a device 40 contains virtual remote control information, the mobile terminal 10 may download the virtual remote control directly from the device 40 (Step 104). Alternatively, the device 40 simply may provide the mobile terminal 10 with manufacturer's information, such as model identification numbers (Step 106). In such embodiments, the mobile terminal 10 may use the information received from the device 40 to download the virtual remote control 18 through its cellular communication interface (Step 108). For example, the mobile terminal 10 may be configured to transmit model information to a certain database 52 accessible through the supporting wireless communication network 50. The database 52 then returns the corresponding virtual remote control 18 to the mobile terminal 10.

FIG. 8 illustrates a similar embodiment, but where communication with the device 40 is not required. In the illustrated embodiment, the mobile terminal 10 receives information from its user regarding model identification (Step 110). The mobile terminal 10 then uses this user-received information to obtain the corresponding virtual remote control 18 through the supporting cellular network (Step 112). In one embodiment, the user may manually enter model information.

However, in other embodiments, the mobile terminal 10 may be configured to display a pick list of manufacturer and model information, to facilitate the user identifying a particular device 40 for which a virtual remote control 18 is desired. In such embodiments, the mobile terminal 10 may locally store pick list information, or may access a server through the wireless communication network, and download pick list information from that server.

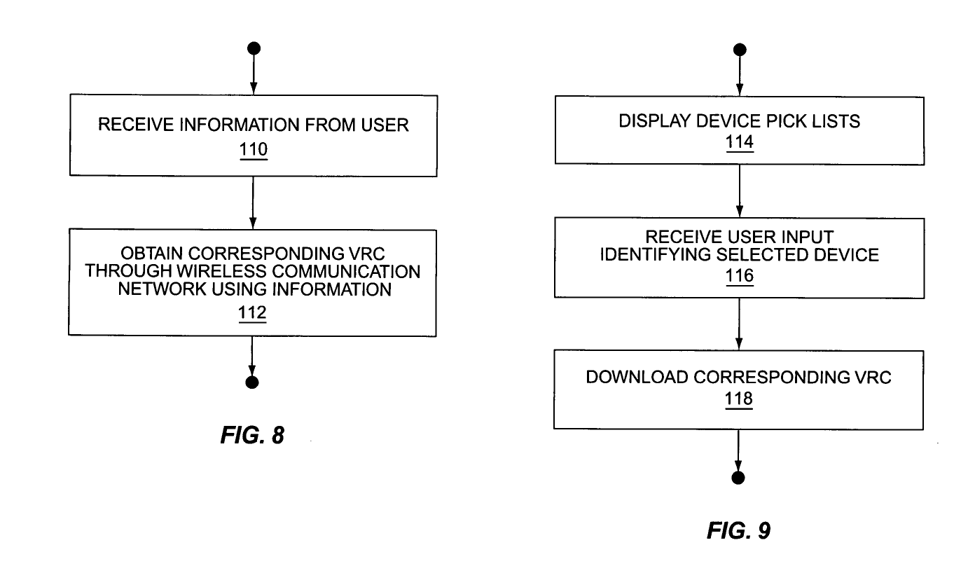

FIG. 9 illustrates an embodiment of such processing, wherein the mobile terminal 10 displays device pick lists, which may comprise an organized list of manufacturers and models (Step 114). The mobile terminal 10 receives user input identifying a selected device (Step 116). Here, the user input may comprise inputs obtained via the controls 14, or may comprise touch screen inputs, assuming that the display screen 16 comprises a touch screen display. Regardless, the mobile terminal 10 receives user input identifying the selected device, transmits that information to the appropriate server 52 through the supporting wireless communication network 50, and downloads the corresponding virtual remote control 18 (Step 118).

The above-described downloading process also may be carried out on a PC or other Internet-enabled device, and the virtual remote control 18 then can be transferred from the PC to the mobile terminal 10, such as through the local communication interface 48. To that end, the local communication interface 48 may include a data interface supporting PC connection (e.g., USB, iRDA, etc.).

Whether done directly through the mobile terminal 10, or done through a PC with an Internet connection, the operator of the wireless communication network 50 may control the database 52 of virtual remote controls, or it may be controlled by a third party. In either case, users may be charged flat or per-transaction rates for accessing the database and downloading virtual remote controls, and manufacturers might advertise the availability of virtual remote controls 18 for their devices as an additional selling feature. Indeed, the device manufacturers may develop sophisticated virtual remote controls 18 that provide more or improved functionality, as compared to the dedicated (physical) remote controls associated with their devices.

Of course, those skilled in the art will appreciate that the present invention is not limited to the features and advantages detailed in the foregoing description, nor is it limited by the accompanying drawings. Indeed, the present invention is limited only by the following claims, and their legal equivalents.

What is claimed is:

1. A method of supporting remote control of other devices by a mobile terminal comprising:
downloading a virtual remote control to the mobile terminal for a device to be controlled by the mobile terminal, said virtual remote control including a graphical interface corresponding to the device;
displaying the virtual remote control on a display screen of the mobile terminal;
and
transmitting commands to the device responsive to receiving user inputs directed to the virtual remote control.

2. The method of claim 1, wherein downloading the virtual remote control to the mobile terminal comprises receiving the virtual remote control from the device through a local communication link between the mobile terminal and the device.

3. The method of claim 1, wherein downloading the virtual remote control to the mobile terminal comprises downloading the virtual remote control from a wireless communication network that stores or otherwise has access to virtual remote control information.

4. The method of claim 3, further comprising receiving identifying information for the device, and using that identifying information to download the virtual remote control corresponding to the device from the wireless communication network.

5. The method of claim 4, wherein receiving identifying information for the device comprises receiving identifying information from the device through a local communication interface of the mobile terminal.

6. The method of claim 1, wherein downloading the virtual remote control to the mobile terminal comprises the mobile terminal detecting the device, establishing a local communication link with the device, and downloading the virtual remote control from the device.

7. The method of claim 1, wherein downloading the virtual remote control to the mobile terminal comprises receiving the virtual remote control through a local communication link with a computer having access to stored virtual remote control information.

8. The method of claim 1, wherein displaying the virtual remote control on the display screen of the mobile terminal comprises displaying a graphic representing at least a portion of a control layout of a dedicated remote control associated with the device.

9. The method of claim 8, wherein displaying the graphic representing at least a portion of the control layout of the dedicated remote control comprises displaying a graphical skin representing all or part of the dedicated remote control.

10. The method of claim 8, wherein the display comprises a touch screen, and wherein transmitting commands to the device comprises receiving touch screen inputs corresponding to virtual remote control functions, and transmitting corresponding device commands to the device through a remote control interface of the mobile terminal.

11. A mobile terminal comprising:
a communication interface;
a remote control interface;
a display screen; and
one or more processing circuits configured to:
download a virtual remote control via the communication interface, said virtual remote control including a graphical interface corresponding to a device to be controlled by the mobile terminal;
display the virtual remote control on the display screen; and
transmit remote control commands to the device via the remote control interface responsive to user inputs directed to the virtual remote control.

12. The mobile terminal of claim 11, wherein the communication interface comprises a cellular communication interface, and wherein the mobile terminal is configured to download the virtual remote control via the cellular communication interface.

13. The mobile terminal of claim 11, wherein the communication interface comprises a local communication interface, and wherein the mobile terminal is configured to download the virtual remote control via the local communication interface.

14. The mobile terminal of claim 13, wherein the local communication interface is configured to communicate with the device, and wherein the mobile terminal is configured to download the virtual remote control from the device.

15. The mobile terminal of claim 13, wherein the local communication interface is configured to communicate with a computer, and wherein the mobile terminal is configured to download the virtual remote control from the computer.

16. The mobile terminal of claim 11, wherein the mobile terminal is configured to receive identifying information for the device, and configured to use that identifying information to download the virtual remote control corresponding to the device via the communication interface.

17. The mobile terminal of claim 11, wherein the mobile terminal is configured to display the virtual remote control on the display screen as a graphic representing at least a portion of a control layout of a dedicated remote control associated with the device.

18. The mobile terminal of claim 17, wherein the mobile terminal is configured to display the graphic as a graphical skin representing all or part of the dedicated remote control.

19. The mobile terminal of claim 17, wherein the display screen comprises a touch screen, and wherein the mobile terminal is configured to receive touch screen inputs corresponding to virtual remote control functions, and to transmit corresponding commands to the device through the remote control interface.
